(19) United States
(12) Patent Application Publication
(10) Pub. No.: US 2025/0133413 A1
(43) Pub. Date: Apr. 24, 2025

(54) WIRELESS COMMUNICATION DEVICE AND METHOD

(71) Applicant: Sony Group Corporation, Tokyo (JP)

(72) Inventor: Shigeru SUGAYA, Tokyo (JP)

(73) Assignee: Sony Group Corporation, Tokyo (JP)

(21) Appl. No.: 18/683,774

(22) PCT Filed: Mar. 9, 2022
(86) PCT No.: PCT/JP2022/010203

§ 371 Date: Feb. 15, 2024

(30) Foreign Application Priority Data
Aug. 27, 2021 (JP) 2021-138899

(51) Int. Cl. H04W 16/14; H04L 5/00; H04W 74/0816

(52) U.S. Cl. CPC H04W 16/14; H04L 5/0012; H04L 5/0053; H04W 74/0816

(57) ABSTRACT

The present technology relates to a wireless communication device and method capable of reliably performing communication of a wireless LAN system even in an environment where other wireless communication systems having different signal formats exist.

The wireless communication device detects a frequency hopping signal from a frequency hopping communication system that operates periodically, predicts a first interference timing at which the frequency hopping signal interferes from a signal detection timing at which the frequency hopping signal is detected, and transmits a frame while avoiding the first interference timing. The present technology can be applied to a wireless communication system.

### TECHNICAL FIELD

The present technology relates to a wireless communication device and method, and more particularly, to a wireless communication device and method capable of reliably performing communication of a wireless local area network (LAN) system even in an environment where other wireless communication systems having different signal formats exist.

### BACKGROUND ART

Since a wireless LAN system can easily use high-speed and large-capacity communication and uses a frequency band that is internationally recognized for use, the wireless LAN system is widely used all over the world today.

Meanwhile, as a wireless communication system using the same frequency band as that of the wireless LAN system, there is an FH communication system using a frequency hopping (FH) technology such as Bluetooth (registered trademark) low energy (LE).

In order for these two wireless communication systems to utilize the same 2.4 GHz band referred to as the ISM band, it has been necessary to eliminate interference between different wireless communication systems in the same frequency band, and to construct a mechanism in which both wireless communication systems coexist.

Therefore, the IEEE 802 Technical Committee has conducted a technical study for coexistence of both wireless communication systems, the Bluetooth technology is defined in the IEEE 802.15.1 standard, and the IEEE 802.15.2 standard that coexists with the Bluetooth technology has been formulated. That is, in the IEEE 802.15.2 standard, a technology of limiting a channel that performs FH in a case where another wireless communication system such as a wireless LAN system is detected is defined.

At present, in a wireless LAN system, it is possible to newly use a frequency band of a 6 GHz band, and a concern about exhaustion of frequency resources is being eliminated for the time being.

However, in other wireless communication systems, there is a movement to use a frequency band of a 6 GHZ band. For example, in Bluetooth, use of these frequency bands has been studied.

In an FH communication system such as Bluetooth LE, transmission is continued even if a signal of a wireless LAN system is detected in order to perform communication by switching frequencies. Therefore, in this FH communication system, the probability that the communication of the FH technology succeeds increases, but the probability that the communication of the wireless LAN system fails increases.

In particular, in the FH communication system, since a narrow-band signal is transmitted as a single shot in time, it is difficult to observe a carrier wave and detect that a transmission path is used as in a wireless LAN system or the like.

As described above, the IEEE 802.15.2 standard is standardized to prevent interference, but Bluetooth is to operate according to this standard only in a case where a wireless LAN system is present in advance. Therefore, this standard is practically used only in a case where the wireless LAN system continuously performs data transmission. That is, a signal that gives interference is transmitted from Bluetooth for the data transmission of the wireless LAN system in which the data transmission is started.

Note that Bluetooth is a standard in which a signal format is changed according to the Low Energy standard, and an advertisement channel is arranged in a gap between channels used in a wireless LAN system and the like, for example, to enhance resistance. However, since the data channel is transmitted at the frequency used by the wireless LAN system, it can be said that the interference with the wireless LAN system is not resolved.

In addition, in the frequency band to be newly used, the originally assumed throughput may not be realized due to the presence of other wireless communication systems. That is, even if the use is distributed by fair access control in the wireless LAN system, there is a possibility that the communication itself in the wireless LAN system is not established due to interference of signals from other wireless communication systems.

From the above, currently, as a method of substantially coexisting with the FH communication system, there is only a method of using a frequency channel avoiding interference by adding a circuit for determining whether or not an existing FH communication system is operating in a wireless LAN system to be added later (see Patent Document 1).

### CITATION LIST

### Patent Document

Patent Document 1: WO 2020/201679

### SUMMARY OF THE INVENTION

### Problems to be Solved by the Invention

As described above, there is an urgent need for a method capable of reliably performing communication of a wireless LAN system in an environment in which there is another wireless communication system having a different signal format using the same frequency band as that of the wireless LAN system.

The present technology has been made in view of such a situation, and makes it possible to reliably perform communication of a wireless LAN system even in an environment in which other wireless communication systems having different signal formats exist using the same frequency band as that of the wireless LAN system.

### Solutions to Problems

A wireless communication device according to one aspect of the present technology includes: a detection unit that detects a frequency hopping signal from a frequency hopping communication system that periodically operates; a communication control unit that predicts a first interference timing at which interference is periodically received from a signal detection timing at which the frequency hopping signal is detected; and a transmission unit that transmits a frame while avoiding the first interference timing.

A wireless communication device according to another aspect of the present technology includes: a reception unit that receives a first frame including information regarding coexistence with a frequency hopping signal detected from a frequency hopping communication system that periodically operates; and a communication control unit that causes a second frame to be transmitted while avoiding a first interference timing at which interference is received from the frequency hopping signal, on the basis of the information regarding the coexistence.

In one aspect of the present technology, a frequency hopping signal is detected from a frequency hopping communication system that periodically operates, and a first interference timing at which interference is periodically received is predicted from a signal detection timing at which the frequency hopping signal is detected. Then, the frame is transmitted while avoiding the first interference timing.

In another aspect of the present technology, a first frame including information regarding coexistence with a frequency hopping signal detected from a frequency hopping communication system that periodically operates is received, and a second frame is transmitted while avoiding a first interference timing at which interference is received from the frequency hopping signal on the basis of the information regarding coexistence.

### BRIEF DESCRIPTION OF DRAWINGS

FIG. 1 is a diagram illustrating a configuration example of a wireless LAN system according to an embodiment of the present technology.

FIG. 2 is a diagram illustrating an example of a frequency band and channel allocation used in a wireless LAN system.

FIG. 3 is a diagram illustrating an operation frequency channel of the FH communication system.

FIG. 4 is a diagram illustrating a usage mode of a channel in an FH communication system.

FIG. 5 is a block diagram illustrating a configuration example of a wireless communication device.

FIG. 6 is a block diagram illustrating a configuration example of a wireless communication module of FIG. 5.

FIG. 7 is a diagram illustrating a communication sequence of the wireless LAN system of FIG. 1.

FIG. 8 is a diagram illustrating a first configuration example of a data frame.

FIG. 9 is a diagram illustrating a second configuration example of a data frame.

FIG. 10 is a diagram illustrating a third configuration example of a data frame.

FIG. 11 is a diagram illustrating a first configuration example of a frame in which a silent period is set.

FIG. 12 is a diagram illustrating a second configuration example of a frame in which a silent period is set.

FIG. 13 is a diagram illustrating a third configuration example of a frame in which a silent period is set.

FIG. 14 is a diagram illustrating a configuration example of a block ACK frame.

FIG. 15 is a diagram illustrating a configuration example of a frame providing notification of information regarding coexistence.

FIG. 16 is a diagram illustrating an example of parameter information managed by a wireless communication device.

FIG. 17 is a flowchart for explaining data transmission processing of the wireless communication device on the transmission side.

FIG. 18 is a flowchart for explaining ACK reception processing of the wireless communication device on the transmission side.

FIG. 19 is a flowchart for explaining data reception processing of the wireless communication device on the reception side.

FIG. 20 is a flowchart for explaining FH signal detection processing.

FIG. 21 is a block diagram illustrating a configuration example of a computer.

### MODE FOR CARRYING OUT THE INVENTION

Hereinafter, modes for carrying out the present technology will be described. The description will be given in the following order.
1. Wireless LAN System
2. Configuration of Wireless Communication Device
3. Operation of Wireless LAN System
4. Frame Configuration
5. Operation of Wireless Communication Device
6. Others

### 1. Wireless LAN System

### <Configuration of Wireless LAN System>

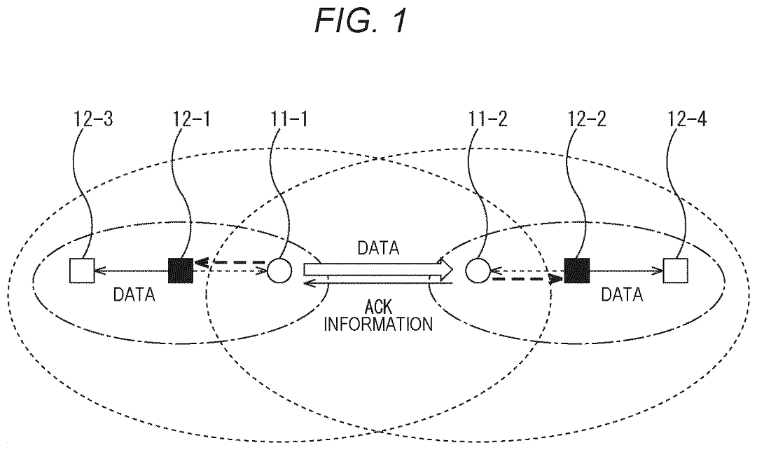

FIG. 1 is a diagram illustrating a configuration example of a wireless LAN system which is a wireless communication system according to an embodiment of the present technology.

The wireless LAN system of FIG. 1 includes wireless communication devices 11-1 and 11-2. The wireless communication devices 11-1 and 11-2 include a smartphone, a mobile phone, a mobile terminal, a personal computer, and the like. Note that, hereinafter, the wireless communication devices 11-1 and 11-2 will be referred to as wireless communication devices 11 unless it is particularly necessary to distinguish them.

The wireless communication device 11-1 transmits data to the wireless communication device 11-2, and receives Acknowledgement (ACK) information which is a data reception acknowledgement response transmitted from the wireless communication device 11-2.

The wireless communication device 11-2 receives data transmitted from the wireless communication device 11-1 and transmits ACK information to the wireless communication device 11-1.

In FIG. 1, a frequency hopping (FH) communication system that performs communication in an FH scheme coexists in the vicinity of the wireless LAN system.

The FH system includes FH communication devices 12-1 to 12-4. The FH communication devices 12-1 to 12-4 include devices that perform communication in the FH scheme represented by a smartphone, a mobile phone, a mobile terminal, a personal computer, a mouse, a headphone, an earphone, a speaker, and the like. Note that, hereinafter, the FH communication devices 12-1 to 12-4 will be referred to as FH communication devices 12 unless it is particularly necessary to distinguish them.

In FIG. 1, when data is transmitted from the wireless communication device 11-1 to the wireless communication device 11-2, the FH communication device 12-1 exists in the vicinity of the wireless communication device 11-1, and the FH communication device 12-2 exists in the vicinity of the wireless communication device 11-2.

Meanwhile, the FH communication device 12-1 transmits data to the paired FH communication device 12-3 by the FH scheme. The FH communication device 12-2 transmits data to the paired FH communication device 12-4 by the FH scheme.

Since the transmission power is suppressed, these signals of the FH scheme are generally used for the purpose of performing near field communication.

In FIG. 1, an ellipse centered on a mark representing the wireless communication device 11-1, the wireless communication device 11-2, the FH communication device 12-1, and the FH communication device 12-2 represents a transmission range of a transmission radio wave of each of the wireless communication device 11-1, the wireless communication device 11-2, the FH communication device 12-1, and the FH communication device 12-2. Therefore, the intersection of these ellipses schematically represents that interference is given to each of the ellipses when each communication is simultaneously executed.

In addition, a broken line arrow from the FH communication device 12-1 to the wireless communication device 11-1 indicates that a signal transmitted from the FH communication device 12-1 reaches the wireless communication device 11-1. Similarly, a broken line arrow from the FH communication device 12-2 to the wireless communication device 11-2 indicates that a signal transmitted from the FH communication device 12-2 reaches the wireless communication device 11-2.

Meanwhile, in a case where data transmission is continuously performed in a predetermined frequency band as in a wireless LAN system, these signals may become noise and reach the FH communication device 12.

That is, a broken line arrow from the wireless communication device 11-1 to the FH communication device 12-1 indicates that data transmitted from the wireless communication device 11-1 reaches the wireless communication device 12-1.

Similarly, a broken line arrow from the wireless communication device 11-2 to the FH communication device 12-2 indicates that the ACK information transmitted from the wireless communication device 11-2 reaches the FH communication device 12-2.

Therefore, in the case of FIG. 1, the data transmitted from the wireless communication device 11-1 interferes with the communication of the FH communication device 12-1, and the ACK information transmitted from the wireless communication device 11-2 interferes with the communication of the FH communication device 12-2.

Therefore, in the wireless LAN system of the present technology, the wireless communication device 11-1 calculates a timing at which the FH communication device 12-1 transmits a signal, and controls transmission of data so as not to interfere with the signal transmitted by the FH communication device 12-1. Similarly, the wireless communication device 11-2 calculates the timing at which the FH communication device 12-2 transmits a signal, and controls the transmission of the ACK information so as not to interfere with the signal transmitted by the FH communication device 12-2.

As described above, the communication of the wireless LAN system can be reliably performed even in an environment in which other wireless communication systems having different signal formats exist using the same frequency band such as the FH scheme.

Hereinafter, the present technology will be described in detail.

### <Frequency Band and Channel Allocation of Wireless LAN System>

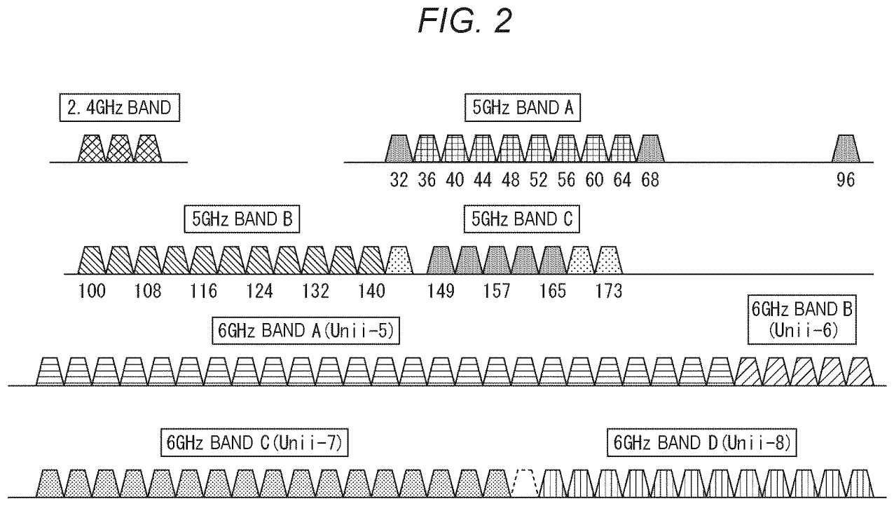

FIG. 2 is a diagram illustrating an example of a frequency band and channel allocation used in a wireless LAN system.

FIG. 2 illustrates available frequency bands and channel allocation situations thereof for the wireless LAN system.

First, in a case where the 2.4 GHz band is applied to a radio signal of an orthogonal frequency division multiplexing (OFDM) scheme of a 20 MHz bandwidth of the IEEE 802.11g standard, a frequency channel of at least about three channels can be set in the 2.4 GHz band.

In addition, in the 5 GHz band, a plurality of channels to be applied to the radio signal of the OFDM scheme of the 20 MHz bandwidth can be secured due to a standard such as IEEE 802.11a.

However, the operation in the 5 GHz band is provided with conditions for determining an available frequency range, transmission power, and transmittable according to the legal system of each country.

In FIG. 2, channel numbers are assigned under the 5 GHz band, but in Japan, eight channels of channels 36 to 64 and 11 channels of channels 100 to 140 can be used.

Note that the channel 32, the channel 68, the channel 96, and the channel 144 can also be used in other countries and regions, and the channels 149 to 173 can be used in a frequency band thereabove.

As for the method of use in the 6 GHz band that is currently being standardized so as to be usable, as illustrated in FIG. 2, 25 channels in the UNII-5 band in the 6 GHz band A, five channels in the UNII-6 band in the 6 GHz band B, 17 channels in the UNII-7 band in the 6 GHZ band C, and 12 channels in the UNII-8 band in the 6 GHZ band D can be arranged.

Note that, in these frequency bands, by using a plurality of bandwidths of 20 MHZ, for example, a bandwidth of 40 MHz can be continuously used by combining two bands, a bandwidth of 80 MHz can be continuously used by combining four bands, and a bandwidth of 160 MHz can be continuously used by combining eight bands.

### <Operation Frequency Channel of FH Communication System>

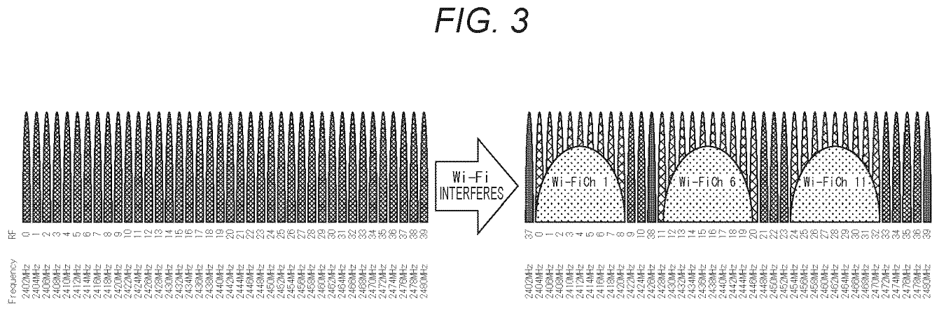

FIG. 3 is a diagram illustrating an operation frequency channel of the FH communication system.

On the left side of FIG. 3, 40 channels for performing communication in the FH scheme using all of the 2.4 GHz band are prepared.

FIG. 3 illustrates RF (RF0 to RF39) representing channel numbers and frequencies (2402 MHz to 2480 MHz) corresponding to the respective RFs.

In this FH communication system, three channels (for example, RF37 to RF39) out of 40 channels are set as advertisement channels, and control information other than data communication is exchanged.

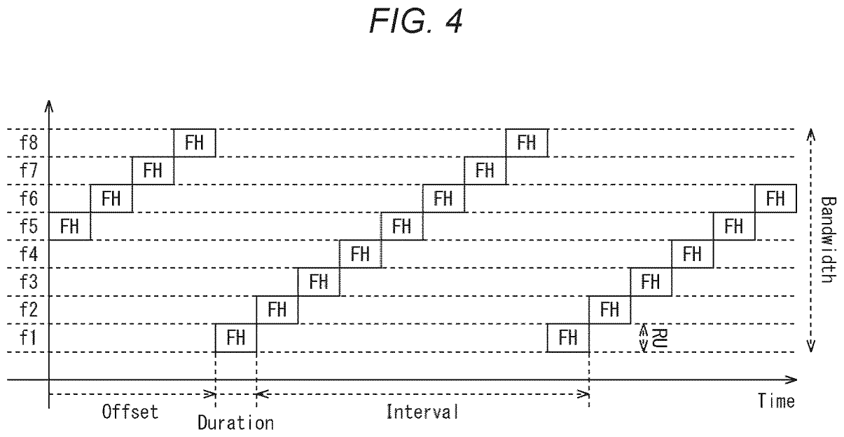

Note that, in the FH communication system, signals are not always continuously transmitted in these channels as in the wireless LAN system, but as will be described later with reference to FIG. 4, the FH communication system is configured to operate by switching frequency channels using one channel only for a short time.

Therefore, a mechanism in which both the wireless LAN system and the FH communication system coexist is standardized in IEEE 802.15.2, and a part thereof is defined as adaptive frequency hopping (AFH).

The AFH sets a channel used for frequency hopping while avoiding a frequency channel used in a wireless LAN system or the like in advance.

The right side of FIG. 3 illustrates a state in which the FH communication system uses a frequency channel not used in the wireless LAN system by AFH.

On the right side of FIG. 3, Wi-Fi ch1 (RF0 to RF8), Wi-Fi ch6 (RF11 to RF20), and Wi-Fi ch11 (RF24 to RF32) compliant with the IEEE 802.11b standard are illustrated as frequency channels used in the wireless LAN system.

Therefore, among the 40 channels, the FH communication system uses 12 channels of RF9, RF10, RF21 to RF23, and RF33 to RF36 in addition to RF37 to RF39 set as the advertisement channels.

Note that, as described above, the AFH is a mechanism in a case where the frequency channel used in the wireless LAN system is known.

Therefore, in a case where communication by the wireless LAN system is not performed and only communication by the FH communication system is performed, the FH communication system performs communication using 40 channels as illustrated on the left side of FIG. 3.

### <Channel Usage Mode in FH Communication System>

FIG. 4 is a diagram illustrating a channel usage mode in the FH communication system.

In FIG. 4, the vertical axis represents the frequency channel, and the horizontal axis represents the transition of time. It should be noted that, for convenience of description, eight channels are illustrated as frequency resource units (RUs), but actually, a frequency shift is performed on each of 40 channels to perform transmission.

That is, the FH signal is transmitted at the frequency f5 at an arbitrary timing, the FH signal is transmitted at the frequency f6 at the next timing, and the FH signal is transmitted at the frequency f7 at the next timing.

Then, after the FH signal is transmitted at the frequency f8, the FH signal is transmitted at the frequency f1.

By such a frequency shift, in a case where the lowest frequency f1 in the frequency band is used as a reference as a parameter in the time axis direction, the timing from the start of detection of the FH signal until the FH signal of the frequency f1 is detected is set as an offset, the cycle until the frequency returns to the frequency f1 again is set as an interval, and the time during which the FH signal is continuously detected is set as a duration.

Further, as a parameter in the frequency direction, a bandwidth in which frequency hopping is continuously performed as a resource unit (RU) is set to a frequency range for detecting an FH signal.

In the wireless communication device 11 of the wireless LAN system of the present technology, the FH signal is detected on the basis of these parameters.

### 2. Configuration of Wireless Communication Device

### <Configuration of Wireless Communication Device>

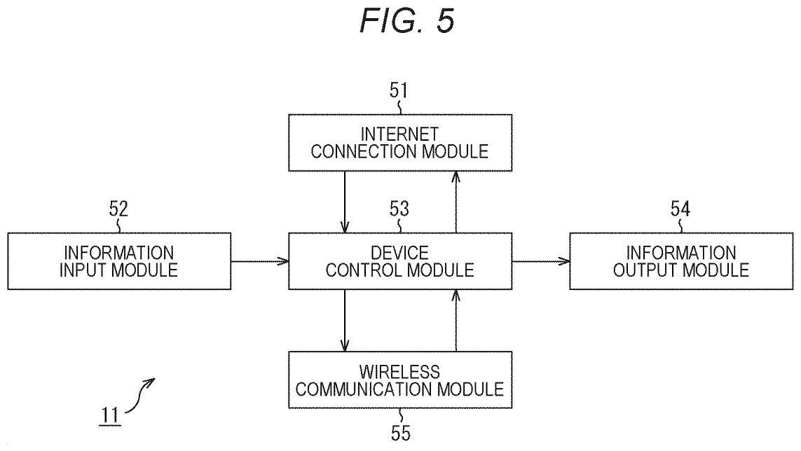

FIG. 5 is a block diagram illustrating a configuration example of the wireless communication device 11.

The wireless communication device 11 in FIG. 5 includes an Internet connection module 51, an information input module 52, a device control module 53, an information output module 54, and a wireless communication module 55.

Note that the wireless communication device may include only necessary modules.

The Internet connection module 51 is configured to implement functions such as a communication modem for connecting to an Internet network in a case of operating as a device of an access point according to control of the device control module 53. The Internet connection module 51 connects a public communication line and the Internet via an Internet service provider.

The information input module 52 outputs information indicating an instruction input by the user to the device control module 53. The information input module 52 includes a push button, a keyboard, a touch panel, and the like.

The device control module 53 includes a central processing unit (CPU), a read only memory (ROM), a random access memory (RAM), and the like. The device control module 53 executes a program stored in the ROM or the like, causes an application to function in a higher layer, and performs control to operate as a wireless communication device or an access point device.

The information output module 54 outputs information regarding the operation state of the wireless communication device 11 or information obtained via the Internet, which is supplied from the device control module 53. The information output module 54 includes a display element such as an LED, a liquid crystal panel, or an organic display, a speaker that outputs sound or music, or the like. The information output module 54 displays and notifies the user of necessary information.

The wireless communication module 55 transmits the data supplied from the device control module 53 to the other wireless communication device 11 by performing wireless communication. The wireless communication module 55 receives data transmitted from another wireless communication device 11 by performing wireless communication, and outputs the received data to the device control module 53.

### <Configuration of Wireless Communication Module>

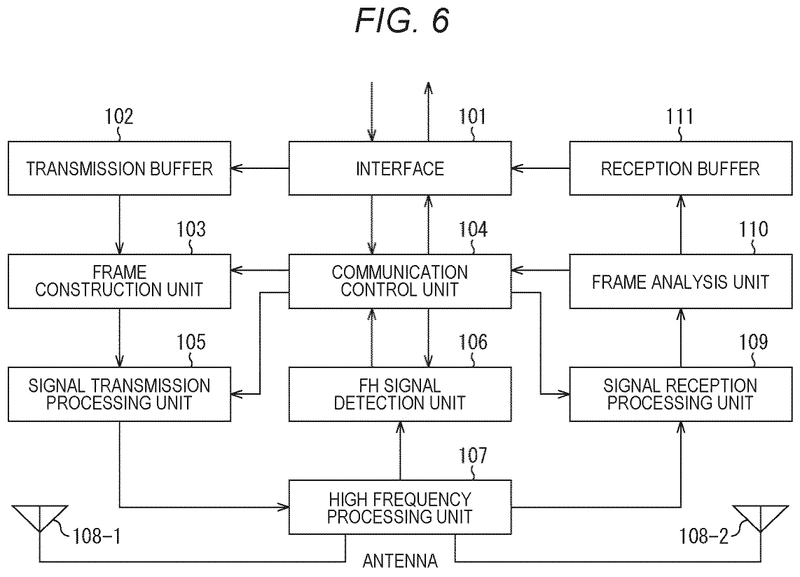

FIG. 6 is a block diagram illustrating a configuration example of the wireless communication module 55.

The wireless communication module 55 includes an interface 101, a transmission buffer 102, a frame construction unit 103, a communication control unit 104, a signal transmission processing unit 105, and an FH signal detection unit 106. Furthermore, the wireless communication module 55 includes a high frequency processing unit 107, antennas 108-1 and 108-2, a signal reception processing unit 109, a frame analysis unit 110, and a reception buffer 111.

The interface 101 functions as an interface for exchanging information input from the user from the device control module 53 and data supplied from the Internet network in a predetermined signal format.

The interface 101 outputs information and data supplied from the device control module 53 to the transmission buffer 102 and the communication control unit 104. The interface 101 outputs information and data supplied from the reception buffer 111 to the device control module 53.

In a case of receiving information input from a user or a signal for performing wireless communication, the transmission buffer 102 temporarily stores the received signal.

In accordance with an instruction from the communication control unit 104, the frame construction unit 103 constructs a data (a MAC layer protocol data unit (MPDU) frame or an A-MPDU (aggregated MPDU)) frame or an ACK frame by using the data accumulated in the transmission buffer 102 and the ACK information supplied from the communication control unit 104. The frame construction unit 103 outputs the constructed frame to the signal transmission processing unit 105.

The communication control unit 104 manages an operation for transmitting and receiving data and ACK information on the basis of the information supplied from the interface 101 and the frame analysis unit 110. The communication control unit 104 grasps the frame construction and the data transmission/reception state, and controls the frame construction unit 103, the signal transmission processing unit 105, the FH signal detection unit 106, and the signal reception processing unit 109.

Furthermore, the communication control unit 104 calculates an interference timing at which interference is received from the FH communication system on the basis of the information supplied from the FH signal detection unit 106, and stores the periodic motion in the built-in memory. The communication control unit 104 causes the frame construction unit 103 to construct the A-MPDU frame and the ACK frame of the wireless LAN system so as not to interfere with the FH communication system, and transmits the A-MPDU frame and the ACK frame via the signal transmission processing unit 105. Note that the interference timing may be a timing at which interference is received from the FH communication system, but may also be a timing at which interference is caused by transmission of a signal from the FH communication system itself. Therefore, hereinafter, it is also referred to as a timing at which interference with the FH signal occurs.

The signal transmission processing unit 105 performs encoding processing on data to be transmitted, and outputs the encoded data to the high frequency processing unit 107.

The FH signal detection unit 106 detects a signal of the FH communication system. Specifically, in order to coexist with the FH communication system, the FH signal detection unit 106 outputs, to the communication control unit 104, information on the signal detection timing, the frequency band, and the received field strength at which the FH signal transmitted from the surrounding FH communication system is detected.

The high frequency processing unit 107 performs predetermined high frequency processing on the data supplied from the signal transmission processing unit 105, and constructs a signal in each frequency band among the plurality of frequency bands. The high frequency processing unit 107 transmits the constructed signal to the wireless communication device 11 of the communication counterpart via the antennas 108-1 and 108-2.

Furthermore, the high frequency processing unit 107 receives a signal in each frequency band transmitted from the wireless communication device 11 of the communication counterpart via the antennas 108-1 and 108-2, and outputs the received signal to the signal reception processing unit 109.

The signal reception processing unit 109 processes the signal supplied from the high frequency processing unit 107 and outputs the processed signal to the frame analysis unit 110.

The frame analysis unit 110 extracts a predetermined data frame from the received data, and extracts various types of information and data such as header information, a delimiter, and a payload from the ACK frame. The frame analysis unit 110 outputs the extracted information to communication control unit 104, and outputs the extracted data to the reception buffer 111.

The reception buffer 111 stores the data supplied from the frame analysis unit 110.

### 3. Operation of Wireless LAN System

### <Communication Sequence of Wireless LAN System>

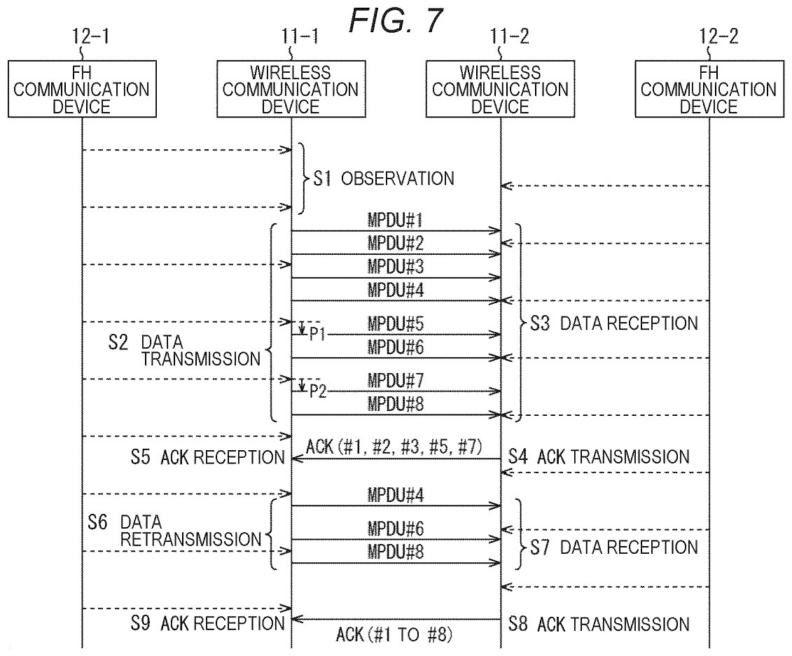

FIG. 7 is a diagram illustrating a communication sequence of the wireless LAN system of FIG. 1.

In FIG. 7, the wireless communication device 11-1 is a wireless communication device on the transmission side. The wireless communication device 11-2 is a wireless communication device on the reception side. As described above with reference to FIG. 1, the FH communication device 12-1 and the FH communication device 12-2 exist around the wireless communication device 11-1 and the wireless communication device 11-2, respectively.

FIG. 7 illustrates an example in which the wireless communication device 11-1 starts transmitting data (MPDUs #1 to #8) to the wireless communication device 11-2 in a state in which the FH communication device 12-1 and the FH communication device 12-2 are already operating.

Note that, in FIG. 7, how each device operates with the lapse of time is illustrated as information exchange downward in the drawing. Further, arrows indicated by broken lines in the drawing indicate that the FH signals are intermittently transmitted from the FH communication devices 12-1 and 12-2, and the FH signals and the wireless communication devices 11-1 and 11-2 interfere with each other.

First, in a case of transmitting data (MPDUs #1 to #8), in step S1, the wireless communication device 11-1 observes a parameter of an FH signal that receives interference from the surrounding FH communication device 12-1, and observes information on a cycle and a duration of the detected FH signal for a predetermined time in a frequency band used for data transmission.

Here, the predetermined time can be, for example, a time equal to or longer than a cycle of an FH signal defined as a standard of an existing FH communication system.

As a result, as illustrated in FIG. 4, since the wireless communication device 11-1 can calculate the parameters of the periodic FH signal of the FH communication device 12-1 existing around the wireless communication device, it is possible to estimate the interference timing at which the wireless communication device interferes with the FH signal in the frequency band used for data transmission.

Then, in step S2, the wireless communication device 11-1 transmits data (MPDUs #1 to #8). At that time, the wireless communication device 11-1 constructs the data as an A-MPDU frame, determines that there is a low possibility of interference in a case where the estimated interference timing falls on the boundary or padding of the MPDU, and determines that there is a possibility of interference in a case where the estimated interference timing falls on the middle of the MPDU (for example, the payload portion).

In a case where the payload portions of the MPDU #5 and the MPDU #7 of the A-MPDU fall on the interference timing, the wireless communication device 11-1 transmits the interference timing at different timings as indicated by an arrow P1 and an arrow P2 so as not to interfere with the FH signal. For example, frames of A-MPDUs are transmitted at staggered timings such that the interference timing falls on the boundary or padding of that MPDU.

Meanwhile, in step S3, the wireless communication device 11-2 receives a data (A-MPDU) frame addressed to itself. In a case of receiving the data (A-MPDU) frame addressed to the wireless communication device 11-2 itself, the wireless communication device 11-2 may periodically interfere with the FH signal transmitted from the FH communication device 12-2 as indicated by a broken line in the drawing.

FIG. 7 illustrates a case where interference timing due to a signal from the FH communication device 12-2 overlaps with reception of payload portions of the MPDU #4, the MPDU #6, and the MPDU #8, and these pieces of data cannot be correctly received. That is, a reception error occurs at a portion where a solid arrow from the wireless communication device 11-1 and a broken line from the FH communication device 12-2 overlap each other.

Then, after receiving the predetermined data A-MPDU, the wireless communication device 11-2 transmits an ACK frame to the wireless communication device 11-1 in step S4.

When the ACK frame is also transmitted at the interference timing at which the wireless communication device 11-1 interferes with the FH signal from the FH communication device 12-1, there is a possibility that the ACK frame is not correctly received. Therefore, the wireless communication device 11-2 controls the ACK frame to be transmitted while avoiding the interference timing.

In particular, in a case where there is undelivered data, the information regarding the interference timing may be described in a header or a delimiter of a data frame as information regarding coexistence with communication of the FH communication device 12-1. In this case, the wireless communication device 11-2 constructs the ACK frame with reference to the parameter information described in the header or the delimiter of the data frame, and performs transmission control.

ACK information is described in the ACK frame, and received data (#1, #2, #3, #5, #7) is described in the ACK information, which indicates that there is undelivered data (#4, #6, #8).

Note that, in this ACK frame, information regarding coexistence with communication of the FH communication device 12-2 in the wireless communication device 11-2 may be further described.

In this case, the wireless communication device 11-1 can configure a frame (A-MPDU) of the retransmission data and retransmit the data while avoiding the interference timing at which the wireless communication device 11-2 interferes with the FH signal.

Then, in step S7, the wireless communication device 11-2 receives data retransmitted at a timing not interfering with the FH signals from the FH communication devices 12-1 and 12-2.

Finally, in a case where all the data are complete, the wireless communication device 11-2 returns an ACK frame indicating that all the data are complete in step S8.

In step S9, the wireless communication device 11-1 receives the ACK frame transmitted from the wireless communication device 11-2. Thereafter, the communication sequence of FIG. 7 ends.

### 4. Frame Configuration

### First Configuration Example of Data Frame

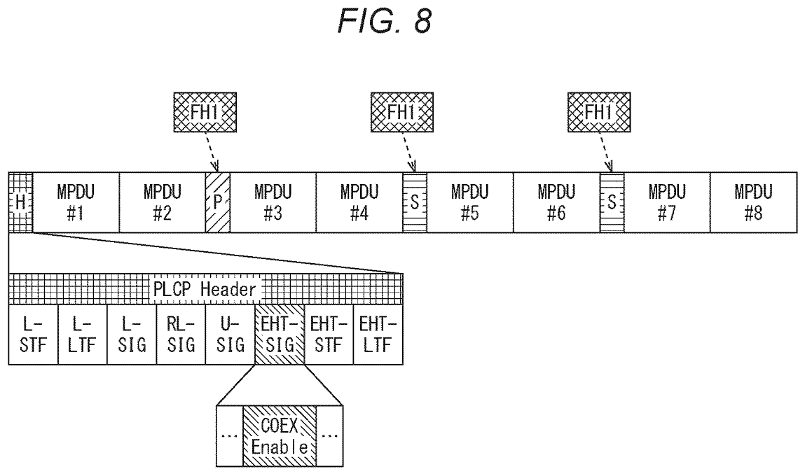

FIG. 8 is a diagram illustrating a first configuration example of a data frame according to the present technology.

The data frame illustrated in FIG. 8 includes an A-MPDU frame in which a predetermined preamble “H” and MPDUs #1 to #8 are concatenated.

Note that, in FIG. 8, FH1 indicated next to the data frame represents an FH signal (hereinafter, the FH1 signal) transmitted by the FH communication device 12-1. This similarly applies to the following diagrams.

The preamble “H” includes, as a predetermined physical layer convergence protocol (PLCP) header, “L-STF”, “L-LTF”, “L-SIG”, “RL-SIG”, “U-SIG”, “EHT-SIG”, “EHT-STF”, and “EHT-LTF”.

“L-STF” is a conventional short training field. “L-LTF” is a conventional long training field. “L-SIG” is conventional signal information, and “RL-SIG” is repetition of L-SIG information.

“U-SIG” is signal information updated for each predetermined version. “Extremely high throughput (EHT)—SIG”is signal information in the current latest version (hereinafter referred to as EHT version). “EHT-STF” is a short training field in the EHT version. “EHT-LTF” is a long training field in the EHT version.

“EHT-SIG” includes a “COEX Enable” bit. “COEX Enable” bit is information regarding coexistence for identifying whether or not a coexistence operation with the FH communication system can be performed.

In the A-MPDU frame, MPDUs #1 to #8, a portion “P” transmitted as padding at the boundary of the MPDU, and a silent period “S” are arranged. The A-MPDU frame is constructed such that, during the transmission of this frame, in a case where there is a possibility of interference with the FH1 signal, “P” or “S” is placed at a position where interference is predicted.

That is, the wireless communication device 11-1 predicts in advance the interference timing at which the interference with the periodically transmitted FH1 signal occurs from the signal detection status of the surrounding FH communication device 12-1, arranges the MPDU such that the padding “P” arrives between the MPDU #2 and the MPDU #3 so as to match the interference timing from the frame start timing, finely adjusts the frame start timing, and configures the A-MPDU frame. Note that, in these padding, processing of actually filling data with a predetermined bit may be performed, or transmission may be performed with transmission power suppressed.

In addition, in a case where the interference timing of the FH1 signal is predicted in the middle of the MPDU #5, the wireless communication device 11-1 inserts a silent period “S” in advance between the MPDU #4 and the MPDU #5 until the interference timing ends so as not to interfere with the FH1 signal by transmission of the MPDU #5.

Furthermore, in a case where the interference timing of the FH1 signal is predicted in the middle of the MPDU #7, the wireless communication device 11-1 inserts a silent period “S” in advance between the MPDU #7 and the MPDU #8 until the interference timing ends, so as not to interfere with the FH1 signal by transmission of the MPDU #7.

### Second Configuration Example of Data Frame

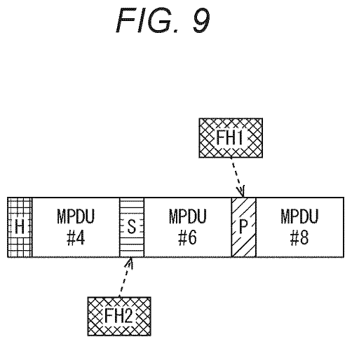

FIG. 9 is a diagram illustrating a second configuration example of the data frame according to the present technology.

FIG. 9 illustrates an example of a retransmission data frame (hereinafter, the frame is also referred to as a retransmission frame) configured on the basis of the information regarding coexistence transmitted from the wireless communication device 11-2 on the reception side.

Note that, in FIG. 9, FH1 indicated next to the data frame is an FH1 signal transmitted by the FH communication device 12-1, and FH2 indicated next to the data frame indicates a signal (hereinafter, the FH2 signal) transmitted by the FH communication device 12-2. This similarly applies to the following diagrams.

The retransmission frame in FIG. 9 is a frame for retransmitting the MPDU #4, the MPDU #6, and the MPDU #8. The retransmission frame is configured to avoid not only interference with the FH1 signal of the FH communication device 12-1 around the wireless communication device 11-1 on the transmission side but also interference with the FH2 signal from the FH communication device 12-2 around the wireless communication device 11-2 on the reception side.

That is, the wireless communication device 11-1 sets a silent period “S” after the MPDU #4, and configure the retransmission frame to finely adjust the frame start timing so that the wireless communication device 11-2 does not interfere with the FH2 signal at the time of reception and so that the wireless communication device 11-1 does not interfere with the FH1 signal at the time of transmission by the padding “P” of the MPDU #6.

### Third Configuration Example of Data Frame

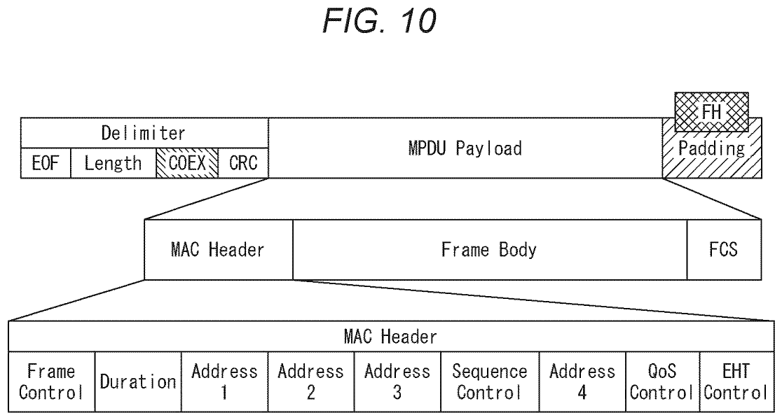

FIG. 10 is a diagram illustrating a third configuration example of the data frame according to the present technology.

FIG. 10 illustrates an example of a delimiter indicating a boundary of an A-MPDU frame and a data frame in which padding is added to an MPDU payload.

The delimiter includes fields of EOF, Length, COEX, and CRC. That is, in the case of FIG. 10, a “COEX” field is added to the delimiter to identify that the frame configuration is a frame configuration that coexists with the FH signal.

The MPDU payload is configured such that a frame body and a frame check sequence “FCS” for error detection are added to a predetermined MAC header.

The MAC header includes fields such as Frame Control, Duration, address fields of Address1 to Address3, Sequence Control, Address4, Qos Control, and EHT Control.

Frame Control includes information used for frame control and the like.

Duration includes information indicating the duration of the frame.

Address field includes address information.

Sequence Control includes a sequence number and the like.

QOS Control includes QOS parameters and the like.

EHT Control includes parameters controlled in the EHT version.

Here, FIG. 10 illustrates a case where the interference timing with the FH signal is included in the period of the padding. By appropriately arranging the padding in the frame, the data frame of the A-MPDU in which the MPDUs are continuously configured can coexist with the surrounding FH signal.

### First Configuration Example of Frame in which Silent Period is Set

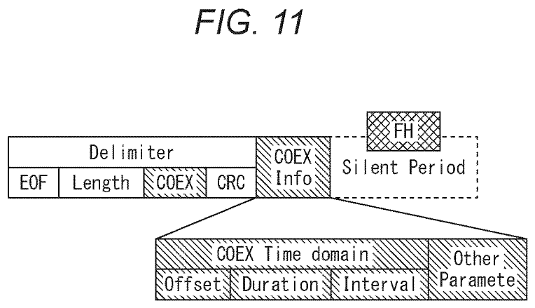

FIG. 11 is a diagram illustrating a first configuration example of a frame in which a silent period is set.

FIG. 11 illustrates an example of a frame to which a delimiter indicating that the silent period is configured is added instead of the MPDUs constituting the A-MPDU described above, and the silent period is set, for example, over the length described in “Length” of the delimiter.

In addition, this frame may be configured to be transmitted by adding a “COEX Info” field in which information regarding coexistence is described in addition to the delimiter as necessary.

In the case of FIG. 11, in the “COEX Info” field, parameters related to coexistence such as offset information Offset, duration information Duration, and interval information Interval are described as information of the COEX time domain in the COEX information.

Then, in the wireless communication device 11-1, in order to actually coexist with the FH signal, control is performed to temporarily suspend signal transmission or suppress transmission power in a silent period (that is, up to the next delimiter) including the interference timing of the FH signal.

Note that, in the “COEX Info” field, other parameters related to coexistence and the like among the COEX information may be described as illustrated in FIG. 11.

### Second Configuration Example of Frame in which Silent Period is Set

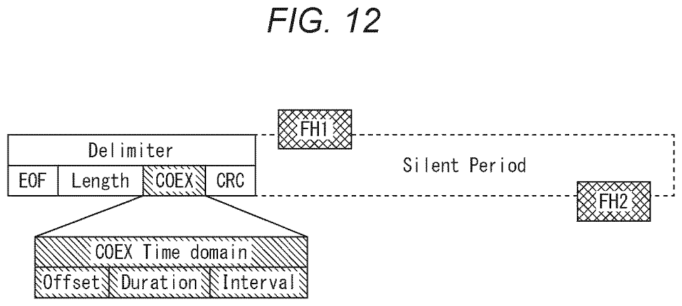

FIG. 12 is a diagram illustrating a second configuration example of a frame in which a silent period is set.

FIG. 12 illustrates an example of a frame in which a silent period is set over a period in which a plurality of FH signals is received in order to avoid interference with the FH1 signal detected by the wireless communication device 11-1 on the transmission side and the FH2 signal detected by the wireless communication device 11-2 on the reception side, for example.

That is, the length of the silent period in consideration of the period in which the plurality of FH signals is received is set in “Length” of the delimiter in FIG. 12.

As described above, in a case where there are interference timings of a plurality of temporally close FH signals, a method of avoiding interference with the FH1 signal and the FH2 signal and coexisting with the FH communication devices 12-1 and 12-2 by providing one silent period without individually providing the silent period may be adopted.

Note that, in the “COEX” field of the delimiter in FIG. 12, parameters regarding coexistence, such as the offset information Offset, the duration information Duration, and the interval information Interval, which are described as the COEX time domain information in the information COEX Info regarding coexistence in FIG. 11, are described.

In other words, as illustrated in FIG. 12, for example, a parameter regarding coexistence or the like may be described in the “COEX” field of the delimiter as long as the specified size in the delimiter is not exceeded.

### Third Configuration Example of Frame in which Silent Period is Set

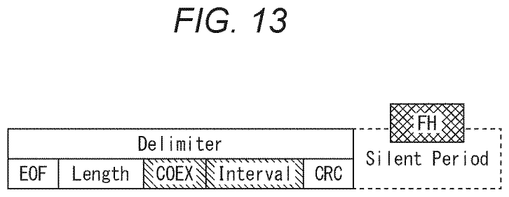

FIG. 13 is a diagram illustrating a third configuration example of a frame in which a silent period is set.

FIG. 13 illustrates an example of a frame for providing notification of a silent period by storing an Interval field in which only the minimum necessary interval information Interval is described in a delimiter without adding a field of the information COEX Info regarding coexistence in the frame.

That is, since it is sufficient that the wireless communication device 11-2 on the reception side can detect only the delimiter, the wireless communication device 11-1 stops the transmission or suppresses the transmission power for a period of the length Length (that is, the silent period) after the delimiter.

### Configuration Example of Block ACK Frame

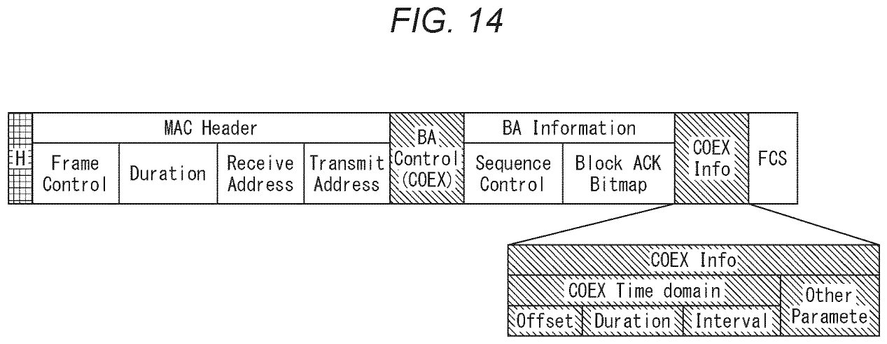

FIG. 14 is a diagram illustrating a configuration example of a block ACK frame according to the present technology.

The block ACK frame illustrated in FIG. 14 includes fields of a predetermined preamble “H”, Frame Control, Duration, Receive Address, Transmit Address, BA Control, BA Information, COEX Info, and FCS.

Frame Control and Duration are similar to those in FIG. 10.

Duration includes information indicating a duration.

Receive Address includes information for identifying a reception destination.

Transmit Address includes information for identifying a transmission side.

BA Control includes control information such as a type of a block ACK frame.

BA Information includes block ACK information.

COEX Info includes information regarding coexistence.

In this COEX Info, for example, a detection status of a signal from the FH communication device 12 existing in the surroundings is described as a parameter.

For example, COEX Info includes subfields of an offset (Offset) indicating a timing from the start of detection to detection of a signal of a predetermined frequency, a duration (Duration) indicating a time during which the signal continues to be detected as an FH signal, and an interval (Interval) indicating a cycle until the signal is detected again at the same frequency, as time domains related to coexistence.

Note that other parameters regarding coexistence may be described in the field of COEX Info.

The FCS includes information for error detection.

As illustrated in FIG. 14, the wireless communication device 11-2 notifies the wireless communication device 11-1 of COEX Info, which is information regarding coexistence, by using a block ACK frame, so that the wireless communication device 11-1 can calculate a timing at which it does not interfere with the FH signal on both the transmission side and the reception side.

### Configuration Example of Frame for Providing Notification of Information Regarding Coexistence

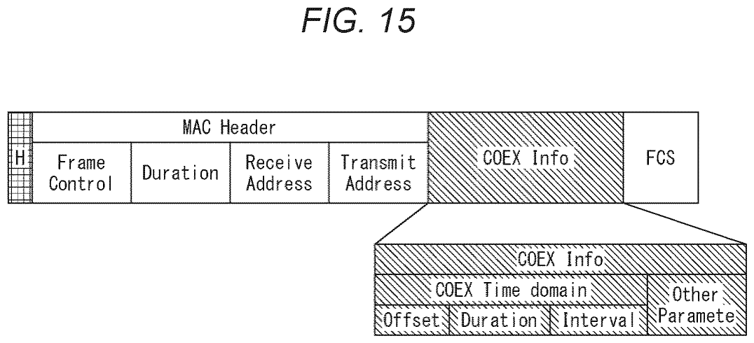

FIG. 15 is a diagram illustrating a configuration example of a frame that provides notification of information regarding coexistence of the present technology.

FIG. 15 illustrates a configuration example of a frame in which these parameters are configured as information elements. This frame is configured as, for example, an action frame, a management frame, or a part of a control frame.

The frame in FIG. 15 includes Frame Control, Duration, Frame Control, Duration, Receive Address, Transmit Address, COEX Info, and FCS in a predetermined PLCP header “H”.

That is, the frame of FIG. 15 is similar to that of FIG. 14 except that BA Control and BA Information are removed.

### <Parameter Information Managed by Wireless Communication Device>

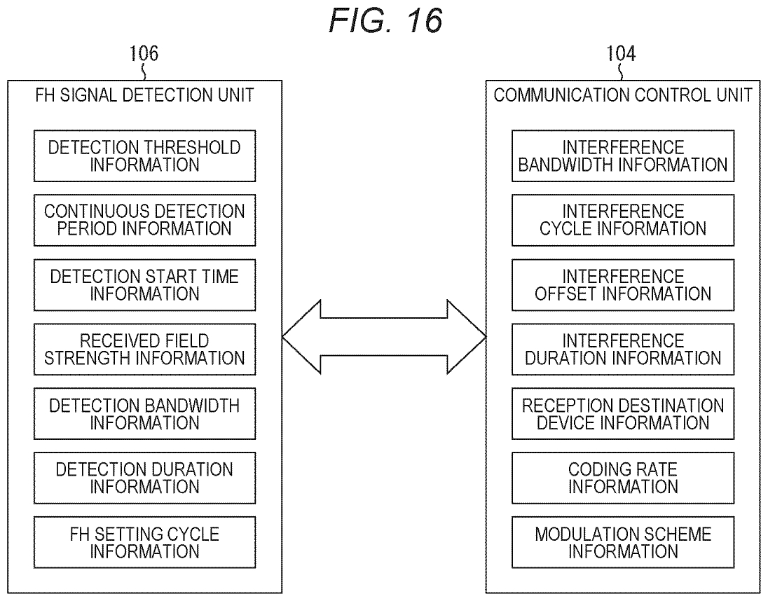

FIG. 16 is a diagram illustrating an example of parameter information managed by the wireless communication device 11.

Various parameters exchanged between the communication control unit 104 and the FH signal detection unit 106 in a case where the wireless communication device 11 operates are described.

The FH signal detection unit 106 outputs continuous detection period information and detection threshold information regarding a period during which the FH signal is continuously detected to the communication control unit 104.

Thereafter, the FH signal detection unit 106 starts predetermined clocking, and in a case where the FH signal is detected, acquires detection start time information, received field strength information thereof, detection bandwidth information that is information of a bandwidth of a detected frequency, and detection duration information that is information of a duration of the detected signal. The FH signal detection unit 106 sequentially notifies the communication control unit 104 of these pieces of parameter information.

Note that, in a case where a plurality of FH signals having the same frequency is detected from the FH signal detection unit 106 during the continuous detection period, the communication control unit 104 may sequentially add and provide notification of FH detection cycle information that is information of the detection cycle. Alternatively, these detection cycles may be set as a result of analysis by the communication control unit 104, and may be provided in notification as FH setting cycle information.

Upon receiving the parameter information detected by the FH signal detection unit 106, the communication control unit 104 stores the parameter information as interference offset information, interference bandwidth information, and interference duration information. The communication control unit 104 may calculate interference cycle information by calculating a cycle at which interference occurs from these pieces of information.

That is, the communication control unit 104 calculates, from the parameter information detected by the FH signal detection unit 106, information regarding coexistence with signals from the surrounding FH communication devices 12 (interference bandwidth information, interference cycle information, interference offset information, and interference duration information).

In addition, the communication control unit 104 also stores information regarding communication parameters such as receiving destination device information which is address information of a wireless communication device which is a counterpart of data communication, coding rate information used for communication with the communication device, and modulation scheme information.

Note that these parameters are merely a part of information necessary for explaining the present technology, and only a part of the parameters described here may be used, or other parameters may be used as appropriate.

### 5. Operation of Wireless Communication Device

### <Data Transmission Processing>

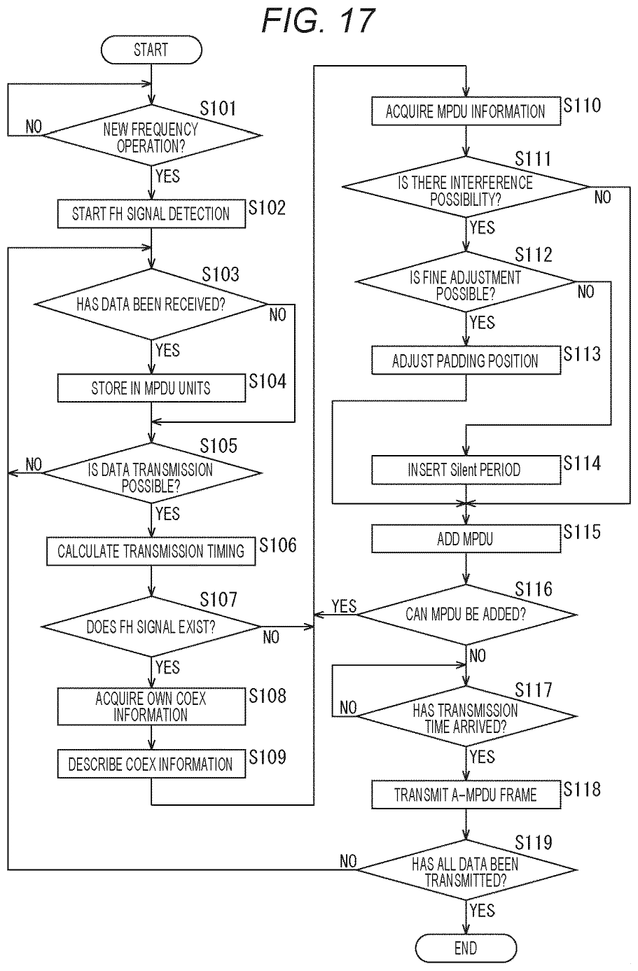

FIG. 17 is a flowchart for explaining data transmission processing of the wireless communication device 11-1 on the transmission side.

In step S101, the communication control unit 104 waits until it is determined that it operates in a new frequency band. In a case where it is determined in step S101 that the own device operates in the new frequency band, the processing proceeds to step S102.

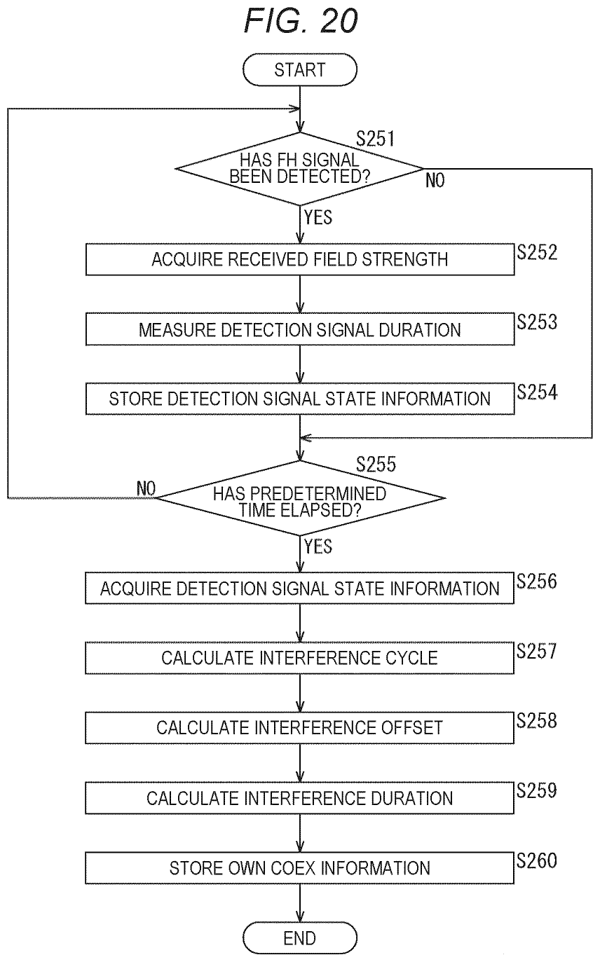

In step S102, the FH signal detection unit 106 starts signal detection processing of the FH communication system. Note that details of the signal detection processing will be described later with reference to FIG. 20.

In step S103, the communication control unit 104 determines whether or not data to be transmitted via the interface 101 has been received. In a case where it is determined in step S103 that the data to be transmitted is received, the processing proceeds to step S104.

In step S104, the communication control unit 104 stores the received data in the transmission buffer 102 in units of predetermined MPDUs.

In a case where it is determined in step S103 that the data to be transmitted is not received, step S104 is skipped, and the processing proceeds to step S105.

In step S105, the communication control unit 104 determines whether or not a predetermined transmission backoff waiting time of access control or the like has elapsed and data transmission is possible. In a case where it is determined in step S105 that the data transmission is not possible, the processing returns to step S103, and the subsequent processing is repeated.

In a case where it is determined in step S105 that data transmission is possible, the processing proceeds to step S106. Note that, here, the processing related to the subsequent frame construction may be executed in advance by the timing at which data transmission becomes possible.

In step S106, the communication control unit 104 calculates a transmission timing at which data can be transmitted.

In step S107, the communication control unit 104 determines whether or not an FH signal has been detected in the surroundings. In a case where it is determined in step S107 that the FH signal is detected in the surroundings, the processing proceeds to step S108.

In step S108, the communication control unit 104 acquires its own COEX information which is information regarding coexistence with the FH signal.

In step S109, the communication control unit 104 performs control to describe the COEX information in a header of a frame or the like.

In a case where it is determined in step S107 that the FH signal has not been detected in the surroundings, the processing in steps S108 and S109 is skipped, and the processing proceeds to step S110.

In step S110, the communication control unit 104 predicts in advance a transmission timing at which a predetermined A-MPDU frame is configured and transmitted, and acquires information of the MPDU. The communication control unit 104 calculates a time related to transmission on the basis of the length of the information of the MPDU and the parameters of the modulation scheme and the coding rate of the data to be transmitted.

In step S111, the communication control unit 104 determines whether or not there is a possibility of interference with the next incoming FH signal. In a case where it is determined in step S111 that there is a possibility of interference, the processing proceeds to step S112.

In step S112, the communication control unit 104 determines whether or not fine adjustment of the timing of the MPDU is possible. In a case where it is determined in step S112 that fine adjustment of the timing of the MPDU is possible, the processing proceeds to step S113.

In step S113, the communication control unit 104 performs control to adjust the padding position at the end of the boundary position of the MPDU. Thereafter, the processing proceeds to step S115.

In a case where it is determined in step S112 that fine adjustment of the MPDU timing is not possible, the processing proceeds to step S114.

In step S114, the communication control unit 104 performs control to insert a silent period including the interference timing of the next incoming FH signal. Thereafter, the processing proceeds to step S115.

Note that, here, in a case where the interference timings of the FH signals are continuous in a short cycle, a silent period including the interference timings of the plurality of FH signals may be set.

In a case where it is determined in step S111 that there is no possibility of interference, the processing proceeds to step S115.

That is, in a case where there is no possibility of interference with the FH signal, or in a case where there is a possibility of natural coexistence, such as a case where the interference timing of the FH signal just corresponds to the padding position of the MPDU, adjustment of the padding position or control of inserting the silent period is not performed.

In step S115, the communication control unit 104 adds the MPDU and constructs an A-MPDU frame.

In step S116, the communication control unit 104 determines whether or not an MPDU can be added to the A-MPDU frame. In a case where it is determined in step S116 that the MPDU can be added, the processing returns to step S110, and the subsequent processing is repeated.

In a case where it is determined in step S116 that the MPDU cannot be added, the processing proceeds to step S117.

In step S117, the communication control unit 104 waits until a transmittable time assumed in advance arrives. In a case where it is determined in step S117 that the transmittable time has come, the processing proceeds to step S118.

In step S118, the communication control unit 104 causes the A-MPDU frame to be transmitted.

In step S119, the communication control unit 104 determines whether or not the transmission of all the data to be transmitted has been completed. In a case where it is determined in step S119 that the transmission of all the data to be transmitted has not been completed yet, the processing returns to step S103.

In a case where it is determined in step S119 that the transmission of all the data to be transmitted has ended, the data transmission processing of FIG. 17 ends.

### <ACK Reception Processing>

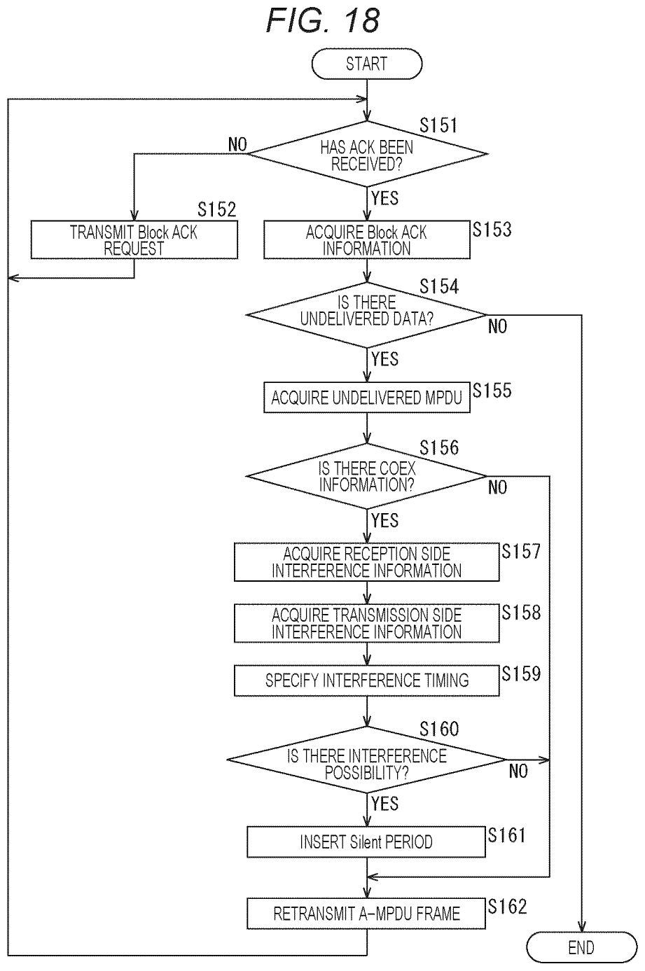

FIG. 18 is a flowchart for explaining ACK reception processing of the wireless communication device 11-1 on the transmission side.

The processing of FIG. 18 is processing performed by the wireless communication device 11-1 on the transmission side after the data transmission of FIG. 17.

The communication control unit 104 of the wireless communication device 11-1 waits for the ACK from the wireless communication device 11-2, and determines whether or not the ACK is received from the wireless communication device 11-2 in step S151. In a case where it is determined in step S151 that the ACK has not been received from the wireless communication device 11-2, the processing proceeds to step S152.

In step S152, the communication control unit 104 transmits a block ACK request and urges the wireless communication device 11-2 to transmit a block ACK frame. Thereafter, the processing returns to step S151, and the subsequent processing is repeated.

In a case where it is determined in step S151 that the ACK is received from the wireless communication device 11-2, the processing proceeds to step S153.

In step S153, the communication control unit 104 acquires the block ACK information included in the block ACK frame.

In step S154, the communication control unit 104 determines, on the basis of the block ACK information, whether or not there is any undelivered data for which reception of the already transmitted data has not been confirmed. In a case where it is determined in step S154 that there is undelivered data, the processing proceeds to step S155.

In step S155, the communication control unit 104 specifies the undelivered data and causes the transmission buffer 102 to acquire the undelivered MPDU.

In step S156, the communication control unit 104 determines whether or not a COEX information element related to coexistence is added to the block ACK frame. In a case where it is determined in step S156 that the COEX information element related to coexistence is added to the block ACK frame, the processing proceeds to step S157.

In step S157, the communication control unit 104 acquires interference information of the FH signal on the reception side.

In step S158, the communication control unit 104 also acquires interference information of the FH signal on the transmission side.

In step S159, the communication control unit 104 calculates and specifies an interference timing at which interference with the FH signal next occurs on the basis of interference information of both the reception side and the transmission side.

In step S160, the communication control unit 104 determines whether or not there is a possibility that the interference timing to interfere with the FH signal next exists in the middle of the MPDU to be retransmitted. Next, in a case where it is determined in step S160 that there is a possibility that the interference timing to interfere with the FH signal exists in the middle of the MPDU to be retransmitted, the processing proceeds to step S161.

In step S161, the communication control unit 104 performs control to insert a silent period including all interference timings at which interference occurs. Thereafter, the processing proceeds to step S162.

In a case where it is determined in step S156 that the COEX information element related to coexistence is not added to the block ACK frame, the processing proceeds to step S162.

In a case where it is determined in step S160 that there is no possibility that the interference timing to interfere with the FH signal next exists in the middle of the MPDU to be retransmitted, the processing also proceeds to step S162.

In step S162, the communication control unit 104 configures an A-MPDU frame from the data (MPDU) to be retransmitted acquired from the transmission buffer 102, and performs retransmission.

After transmitting the retransmission frame in step S162, the processing returns to step S151, and the subsequent processing is repeated. That is, the communication control unit 104 waits for reception of the ACK frame again.

Meanwhile, in a case where it is determined in step S154 that there is no undelivered data, the ACK reception processing ends.

### <Data Reception Processing>

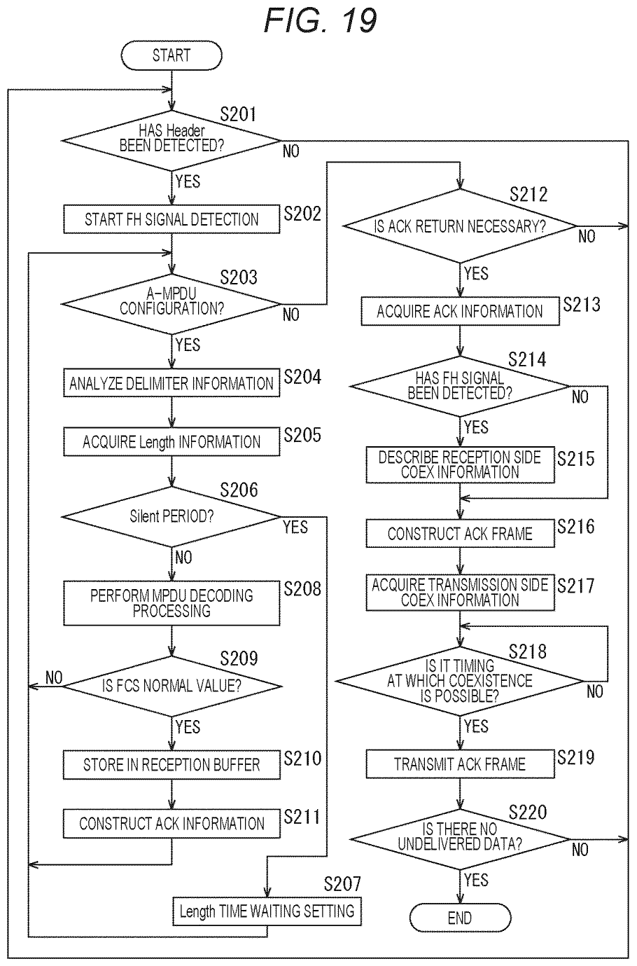

FIG. 19 is a flowchart for explaining data reception processing of the wireless communication device 11-2 on the reception side.

In step S201, the communication control unit 104 of the wireless communication device 11-2 determines whether or not a predetermined PLCP header has been detected. In a case where it is determined in step S201 that the predetermined PLCP header has been detected, the processing proceeds to step S202.

In step S202, the communication control unit 104 starts the FH signal detection processing. Note that details of the signal detection processing will be described later with reference to FIG. 20.

In step S203, the communication control unit 104 determines whether or not a configuration of a frame of a predetermined A-MPDU has been detected. In a case where it is determined in step S203 that the configuration of the frame of the predetermined A-MPDU has been detected, the processing proceeds to step S204.

In step S204, the communication control unit 104 analyzes delimiter information from the frame of the A-MPDU.

In step S205, the communication control unit 104 acquires Length information included in the delimiter information.

In step S206, the communication control unit 104 determines whether or not it is a silent period. In a case where it is determined in step S206 that it is the silent period, the processing proceeds to step S207.

In step S207, the communication control unit 104 sets the time described in the Length information, the processing returns to step S203, and the subsequent processing is repeated. That is, the communication control unit 104 waits for the decoding processing until the time described in the Length information.

In a case where it is determined in step S206 that it is not the silent period, that is, it is the data of the MPDU, the processing proceeds to step S208.

In step S208, the communication control unit 104 causes the decoding processing of the MPDU to be performed.

In step S209, the communication control unit 104 determines whether or not the FCS for error detection is a normal value. In a case where it is determined in step S209 that the FCS for error detection is a normal value, the processing proceeds to step S210.

In step S210, the communication control unit 104 stores data in the reception buffer 111.

In step S211, the communication control unit 104 constructs the sequence number of the data as ACK information. Thereafter, the processing returns to step S203, and the subsequent processing is repeated.

In addition, in a case where it is determined in step S209 that the FCS for error detection is not a normal value, the data is treated as the undelivered data, the processing returns to step S203, and the subsequent processing is repeated.

In a case where it is determined in step S203 that the configuration of the frame of the predetermined A-MPDU has not been detected, for example, in a case where the reception processing of a series of A-MPDU frames ends or a block ACK request frame has been received or the like, the processing proceeds to step S212.

In step S212, the communication control unit 104 determines whether or not it is necessary to return the ACK. In a case where it is determined in step S212 that it is necessary to return the ACK, the processing proceeds to step S213.

In step S213, the communication control unit 104 acquires ACK information.

In step S214, the communication control unit 104 determines whether or not an FH signal has been detected. In a case where it is determined in step S214 that the FH signal has been detected, the processing proceeds to step S215.

In step S215, the communication control unit 104 acquires the COEX information regarding coexistence of the wireless communication device 11-2 on the reception side and describes the COEX information in a predetermined field.

In a case where it is determined in step S214 that the FH signal is not detected, the processing in step S215 is skipped, and the processing proceeds to step S216.

In step S216, the communication control unit 104 constructs a block ACK frame on the basis of the ACK information.

In step S217, the communication control unit 104 acquires COEX information regarding coexistence of the wireless communication device 11-1 on the transmission side.

In step S218, the communication control unit 104 waits until the timing at which coexistence is possible. At that time, the COEX information regarding coexistence of the wireless communication devices 11 on the transmission side and the reception side is referred to. If both, both are referenced, and if only one, one is referenced.

In a case where it is determined in step S218 that the timing at which coexistence is possible has come, the processing proceeds to step S219.

In step S219, the communication control unit 104 transmits a block ACK frame.

In step S220, the communication control unit 104 determines whether or not there is no undelivered data. In a case where it is determined in step S220 that there is no undelivered data, the data reception processing of the wireless communication device 11-2 ends.

In a case where it is determined in step S220 that there is undelivered data, the processing returns to step S201, and the subsequent processing is repeated.

In a case where it is determined in step S201 that the predetermined PLCP header has not been detected, or in a case where it is determined in step S212 that it is not necessary to return the ACK, the processing returns to step S201, and the subsequent processing is repeated.

### <FH Signal Detection Processing>

FIG. 20 is a flowchart for explaining the FH signal detection processing started in step S102 of FIG. 17 and step S202 of FIG. 19.

In step S251, the FH signal detection unit 106 determines whether or not an FH signal exceeding a predetermined received field strength has been detected. In a case where it is determined in step S251 that the FH signal has been detected, the processing proceeds to step S252.

In step S252, the FH signal detection unit 106 acquires received field strength information indicating a peak of the detected FH signal.

In step S253, the FH signal detection unit 106 measures the signal duration of the detected FH signal.

In step S254, the FH signal detection unit 106 stores information (for example, information illustrated in the FH signal detection unit 106 of FIG. 16) indicating the state of the detected FH signal in a built-in memory not illustrated. After step S254, the processing proceeds to step S255.

In a case where it is determined in step S251 that the FH signal is not detected, the processing proceeds to step S255.

Note that the detection operation by the FH signal detection unit 106 may be performed, for example, over a maximum cycle determined in advance according to the Bluetooth communication standard for transmitting the FH signal.

In step S255, the communication control unit 104 determines whether or not a predetermined time has elapsed. In a case where it is determined in step S255 that the predetermined time has elapsed, the processing proceeds to step S256.

In step S256, the communication control unit 104 acquires the detection signal state information indicating the state of the FH signal detected within the predetermined time from the built-in memory of the FH signal detection unit 106.

In step S257, the communication control unit 104 calculates, for example, an interference cycle on the basis of the information indicating the state of the FH signal.

In step S258, the communication control unit 104 calculates, for example, an interference offset from the detection start time to the timing at which the lowest frequency channel that can be a reference is detected.

In step S259, the communication control unit 104 calculates the interference duration which is the duration of one time of the FH signal.

In step S260, the communication control unit 104 stores parameters (for example, information illustrated in the communication control unit 104 of FIG. 16) in which the FH communication device 12 existing around its own device periodically operates as COEX information which is information regarding coexistence. Thereafter, the FH signal detection processing ends.

### 6. Others

### <Effects>

As described above, in the present technology, the FH signal is detected from the FH communication system that periodically operates, the first interference timing that periodically interferes with the frequency hopping signal is predicted from the signal detection timing at which the FH signal is detected, and the frame is transmitted avoiding the first interference timing.

As a result, it is possible to perform signal transmission and reception of the wireless LAN while coexisting with communication using surrounding FH signals, and to operate while respecting mutual communication.

Furthermore, in the present technology, information regarding the first interference timing is included in a frame and transmitted to another wireless communication device.

As a result, since the transmission timing on the reception side is adjusted, the transmitted ACK frame can be reliably received.

In the present technology, a silent period is inserted instead of the MPDU in the middle of the A-MPDU frame to be transmitted.

As a result, the frame can be continuously transmitted while coexisting with the FH signal.

Furthermore, in the present technology, the wireless communication device on the reception side also detects the FH signal and provides notification of the signal detection status by the ACK frame.

As a result, information regarding coexistence on the reception side can be shared, and the retransmission frame can be reliably transmitted.

As described above, according to the present technology, even when the FH communication system operates using all the frequency bands, it is possible to perform communication while avoiding the interference timing of the signal of the FH communication system in the frequency resources transmitted by the wireless LAN system.

### Configuration Example of Computer

The series of processing described above can be executed by hardware and also can be executed by software. In a case where the series of processing is executed by software, a program included in the software is installed from a program recording medium to a computer incorporated in dedicated hardware, a general-purpose personal computer, or the like.

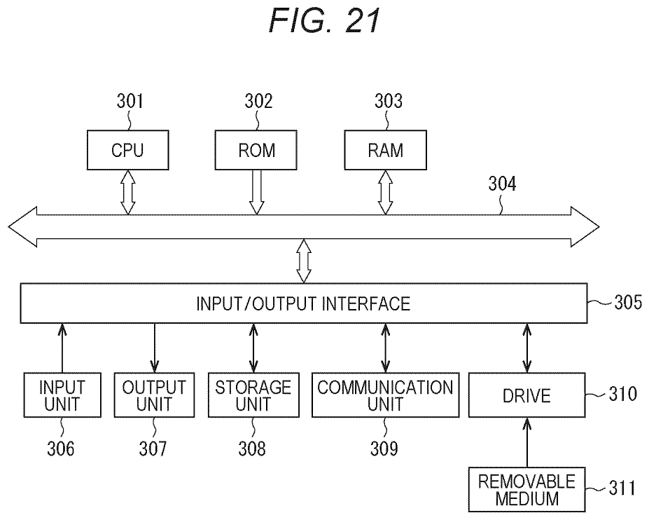

FIG. 21 is a block diagram illustrating a configuration example of hardware of a computer that executes the above-described series of processing by a program.

A central processing unit (CPU) 301, a read only memory (ROM) 302, and a random access memory (RAM) 303 are mutually connected by a bus 304.

Furthermore, an input/output interface 305 is connected to the bus 304. An input unit 306 including a keyboard, a mouse, and the like, and an output unit 307 including a display, a speaker, and the like are connected to the input/output interface 305. In addition, a storage unit 308 including a hard disk, a nonvolatile memory, or the like, a communication unit 309 including a network interface or the like, and a drive 310 that drives a removable medium 311 are connected to the input/output interface 305.

In the computer configured as described above, the series of processing described above is performed, for example, by the CPU 301 loading the program stored in the storage unit 308 into the RAM 303 via the input/output interface 305 and the bus 304 and executing the program.

The program to be executed by the CPU 301 is provided, for example, by being recorded on the removable medium 311 or via a wired or wireless transmission medium such as a local area network, the Internet, or digital broadcasting and is installed in the storage unit 308.

Note that the program executed by the computer may be a program for processing in time series in the order described in the present specification, or a program for processing in parallel or at a necessary timing such as when a call is made.

Note that, in the present specification, a system means an assembly of a plurality of components (devices, modules (parts), and the like), and it does not matter whether or not all the components are located in the same housing. Therefore, a plurality of devices accommodated in separate housings and connected via a network and one device in which a plurality of modules is accommodated in one housing are both systems.

In addition, the effects described in the present specification are merely examples and not restrictive, and there may also be other effects.

Embodiments of the present technology are not limited to the above-described embodiments, and various modifications can be made within a scope not departing from the gist of the present technology.

For example, the present technology can be configured as cloud computing in which one function is shared and jointly processed by a plurality of devices via a network.

Furthermore, each step described in the above-described flowcharts can be executed by one device or shared and executed by a plurality of devices.

Moreover, in a case where one step includes a plurality of processes, the plurality of processes included in the one step can be executed by one device or shared and executed by a plurality of devices.

### Combination Example of Configurations

The present technology may also have the following configurations.

(1)

A wireless communication device including:
a detection unit that detects a frequency hopping signal from a frequency hopping communication system that operates periodically;
a communication control unit that predicts a first interference timing at which the frequency hopping signal periodically interferes from a signal detection timing at which the frequency hopping signal is detected; and
a transmission unit that transmits a frame while avoiding the first interference timing.
   (2)

The wireless communication device according to (1),
in which the communication control unit performs control to include information regarding the first interference timing in the frame and transmit the information to another wireless communication device.
   (3)

The wireless communication device according to (1) or (2),
in which the communication control unit performs control to construct the frame to insert a silent period at the first interference timing.
   (4)

The wireless communication device according to (3),
in which the communication control unit performs control to suspend transmission of the frame while suppressing transmission power in the silent period.
   (5)

The wireless communication device according to (3),
in which the communication control unit includes information indicating that the frame includes the silent period in header information of the frame.
   (6)

The wireless communication device according to (1) or (2),
in which the communication control unit performs control to construct the frame such that the first interference timing is a timing at which a boundary of a MAC layer protocol data unit (MPDU) is reached.
   (7)

The wireless communication device according to any one of (1),
in which the communication control unit performs control to configure the frame as a MAC layer protocol data unit (A-MPDU) aggregated.
   (8)

The wireless communication device according to (7), in which the communication control unit includes information regarding the first interference timing in a delimiter portion of the A-MPDU.

(9)

The wireless communication device according to any one of (1) to (8),
in which the communication control unit calculates the first interference timing on the basis of offset information of the signal detection timing, information of duration of the frequency hopping signal, and information of a cycle in which the frequency hopping signal is detected.
   (10)

The wireless communication device according to any one of (1) to (9),
in which, in a case where information regarding a second interference timing at which the another wireless communication device interferes with the frequency hopping signal is described in information transmitted from the another wireless communication device that receives the frame, the communication control unit calculates the second interference timing on the basis of the information regarding the second interference timing.
   (11)

The wireless communication device according to (10),
in which the communication control unit performs control to transmit the frame while avoiding the second interference timing.
   (12)

The wireless communication device according to (11),
in which the communication control unit performs control to retransmit the frame that needs to be retransmitted while avoiding the second interference timing.
   (13)

A wireless communication method in which
a wireless communication device is configured to:
detect a frequency hopping signal from a frequency hopping communication system that operates periodically;
predict a first interference timing at which the frequency hopping signal interferes from a signal detection timing at which the frequency hopping signal is detected; and
transmit a frame while avoiding the first interference timing.
   (14)

A wireless communication device including:
a reception unit that receives, from another wireless communication device, a first frame including information regarding coexistence with a frequency hopping signal detected from a frequency hopping communication system that operates periodically; and
a communication control unit that performs control to transmit a second frame to the another wireless communication device while avoiding a first interference timing at which the another wireless communication device interferes with the frequency hopping signal on the basis of the information regarding coexistence.
   (15)

The wireless communication device according to (14),
in which the communication control unit extracts information regarding the first interference timing from the information regarding coexistence, and performs control to transmit the second frame addressed to the another wireless communication device on the basis of information regarding the first interference timing.
   (16)

The wireless communication device according to (14) or (15),
in which the communication control unit operates a detection unit that detects the frequency hopping signal in a case where data addressed to the another wireless communication device is detected, and predicts a second interference timing at which the communication control unit interferes with the frequency hopping signal.
   (17)

The wireless communication device according to (16), further including
a transmission unit that transmits the second frame in which information regarding the second interference timing is described.
   (18)

The wireless communication device according to (16),
in which the communication control unit generates the second frame in which an element in which information regarding the second interference timing is described is configured and added to ACK information.
   (19)

The wireless communication device according to (18),
in which the communication control unit describes the information regarding the second interference timing in a case where there is undelivered data in data addressed to the communication control unit itself.
   (20)

A wireless communication method in which
a wireless communication device is configured to:
receive, from another wireless communication device, a first frame including information regarding coexistence with a frequency hopping signal detected from a frequency hopping communication system that operates periodically; and
perform control to transmit a second frame to the another wireless communication device while avoiding a first interference timing at which the another wireless communication device interferes with the frequency hopping signal on the basis of the information regarding coexistence.

### REFERENCE SIGNS LIST

11, 11-1 and 11-2 Wireless communication device
12-1 and 12-2 FH communication device
51 Internet connection module
52 Information input module
53 Device control module
54 Information output module
55 Wireless communication module
101 Interface
102 Transmission buffer
103 Frame construction unit
104 Communication control unit
105 Signal transmission processing unit
106 FH signal detection unit
107 High frequency processing unit
108, 108-1 and 108-2 Antenna
109 Signal reception processing unit
110 Frame analysis unit
111 Reception buffer

1. A wireless communication device comprising:
a detection unit that detects a frequency hopping signal from a frequency hopping communication system that operates periodically;
a communication control unit that predicts a first interference timing at which the frequency hopping signal interferes from a signal detection timing at which the frequency hopping signal is detected; and
a transmission unit that transmits a frame while avoiding the first interference timing.

2. The wireless communication device according to claim 1,
wherein the communication control unit performs control to include information regarding the first interference timing in the frame and transmit the information to another wireless communication device.

3. The wireless communication device according to claim 1,
wherein the communication control unit performs control to construct the frame to insert a silent period at the first interference timing.

4. The wireless communication device according to claim 3,
wherein the communication control unit performs control to suspend transmission of the frame while suppressing transmission power in the silent period.

5. The wireless communication device according to claim 3,
wherein the communication control unit includes information indicating that the frame includes the silent period in header information of the frame.

6. The wireless communication device according to claim 1,
wherein the communication control unit performs control to construct the frame such that the first interference timing is a timing at which a boundary of a MAC layer protocol data unit (MPDU) is reached.

7. The wireless communication device according to claim 1,
wherein the communication control unit performs control to configure the frame as a MAC layer protocol data unit (A-MPDU) aggregated.

8. The wireless communication device according to claim 7,
wherein the communication control unit includes information regarding the first interference timing in a delimiter portion of the A-MPDU.

9. The wireless communication device according to claim 1,
wherein the communication control unit calculates the first interference timing on a basis of offset information of the signal detection timing, information of duration of the frequency hopping signal, and information of a cycle in which the frequency hopping signal is detected.

10. The wireless communication device according to claim 1,
wherein, in a case where information regarding a second interference timing at which the another wireless communication device interferes with the frequency hopping signal is described in information transmitted from the another wireless communication device that receives the frame, the communication control unit calculates the second interference timing on a basis of the information regarding the second interference timing.

11. The wireless communication device according to claim 10,
wherein the communication control unit performs control to transmit the frame while avoiding the second interference timing.

12. The wireless communication device according to claim 11,
wherein the communication control unit performs control to retransmit the frame that needs to be retransmitted while avoiding the second interference timing.

13. A wireless communication method in which a wireless communication device is configured to:
detect a frequency hopping signal from a frequency hopping communication system that operates periodically;
predict a first interference timing at which the frequency hopping signal interferes from a signal detection timing at which the frequency hopping signal is detected; and
transmit a frame while avoiding the first interference timing.

14. A wireless communication device comprising:
a reception unit that receives, from another wireless communication device, a first frame including information regarding coexistence with a frequency hopping signal detected from a frequency hopping communication system that operates periodically; and
a communication control unit that performs control to transmit a second frame to the another wireless communication device while avoiding a first interference timing at which the another wireless communication device interferes with the frequency hopping signal on a basis of the information regarding coexistence.

15. The wireless communication device according to claim 14,
wherein the communication control unit extracts information regarding the first interference timing from the information regarding coexistence, and performs control to transmit the second frame addressed to the another wireless communication device on a basis of information regarding the first interference timing.

16. The wireless communication device according to claim 14,
wherein the communication control unit operates a detection unit that detects the frequency hopping signal in a case where data addressed to the another wireless communication device is detected, and predicts a second interference timing at which the communication control unit periodically interferes with the frequency hopping signal.

17. The wireless communication device according to claim 16, further comprising
a transmission unit that transmits the second frame in which information regarding the second interference timing is described.

18. The wireless communication device according to claim 16,
wherein the communication control unit generates the second frame in which an element in which information regarding the second interference timing is described is configured and added to ACK information.

19. The wireless communication device according to claim 18,
wherein the communication control unit describes the information regarding the second interference timing in a case where there is undelivered data in data addressed to the communication control unit itself.

20. A wireless communication method in which a wireless communication device is configured to:
receive, from another wireless communication device, a first frame including information regarding coexistence with a frequency hopping signal detected from a frequency hopping communication system that operates periodically; and
perform control to transmit a second frame to the another wireless communication device while avoiding a first interference timing at which the another wireless communication device interferes with the frequency hopping signal on a basis of the information regarding coexistence.
